(19) United States
(12) Patent Application Publication
(10) Pub. No.: US 2026/0237545 A1
(43) Pub. Date: Aug. 13, 2026

(54) COMPOSITE MAGNETIC MATERIAL, DUST CORE, AND POWER CHOKE COIL

(71) Applicant: Panasonic Intellectual Property Management Co., Ltd., Osaka (JP)

(72) Inventors: YUMA SASAKI, Osaka (JP); JUNICHI KOTANI, Hyogo (JP)

(21) Appl. No.: 19/158,833

(22) PCT Filed: Feb. 2, 2024
(86) PCT No.: PCT/JP2024/003457

§ 371 Date: Aug. 21, 2025

(30) Foreign Application Priority Data
Mar. 30, 2023 (JP) 2023-056700

(51) Int. Cl. H01F 1/26; H01F 1/147; H01F 27/255

(52) U.S. Cl. CPC H01F 1/26; H01F 1/147; H01F 27/255

(57) ABSTRACT

A composite magnetic material contains iron-based soft magnetic alloy particles, inorganic insulating particles, and a thermosetting resin. A surface of each of the inorganic insulating particles is coated with an amphiphilic molecule including a hydrophobic group and a hydrophilic group. The hydrophobic group includes a hydrocarbon chain, and the hydrophilic group includes at least one of a phosphoric acid group and a phosphate salt.

### TECHNICAL FIELD

The present disclosure relates to a composite magnetic material, a powder magnetic core, and a power choke coil, and particularly to a composite magnetic material, and a powder magnetic core and a power choke coil including a cured product of the composite magnetic material.

### BACKGROUND ART

PTL 1 discloses a composite magnetic body including, for example, metallic magnetic powder and thermosetting resin in which a filling rate of the metallic magnetic powder is 65% by volume or more and 90% by volume or less. PTL 1 mentions that this composite magnetic body may further include an electrical insulating material other than the thermosetting resin, and that the electrical insulating material is particles with plate shapes or needle shapes.

### CITATION LIST

### Patent Literature

PTL 1: Japanese Patent Laid-Open Publication No. 2002-305108

### SUMMARY OF INVENTION

A composite magnetic material according to one aspect of the present disclosure contains iron-based soft magnetic alloy particles, inorganic insulating particles, and a thermosetting resin. Surfaces of the inorganic insulating particles are coated with amphiphilic molecules each including a hydrophobic group and a hydrophilic group. The hydrophobic group includes a hydrocarbon chain. The hydrophilic group includes at least one of a phosphoric acid group and a phosphate salt.

A powder magnetic core of the present disclosure includes a cured product of the composite magnetic material.

A power choke coil disclosed in the present disclosure includes the cured product of the composite magnetic material and a coil conductor. The coil conductor is coated with the cured product of the composite magnetic material.

The present disclosure advantageously suppresses a decrease in relative magnetic permeability of the composite magnetic material while a withstand voltage of the composite magnetic material can be improved.

### BRIEF DESCRIPTION OF DRAWINGS

FIG. 1 is a schematic sectional view of a molded body including a composite magnetic material according to an exemplary embodiment.

FIG. 2A is a schematic exploded perspective view of a magnetic element including a powder magnetic core according to the embodiment.

FIG. 2B is a schematic perspective view of the magnetic element including the powder magnetic core shown in FIG. 2A.

FIG. 3A is a sectional view of a power choke coil along line X-X according to the embodiment.

FIG. 3B is a perspective view of the power choke coil according to the embodiment.

FIG. 4 is a sectional view of a modification of the power choke coil according to the embodiment.

FIG. 5 illustrates a relation between a magnetic field and a relative magnetic permeability of Comparative Example 1, Comparative Example 2, and Example 1.

FIG. 6 illustrates a relation between a magnetic field and a relative magnetic permeability of Comparative Example 1, Comparative Example 3, and Example 2.

FIG. 7 illustrates a relation between a magnetic field and a relative magnetic permeability of Comparative Example 1, Comparative Example 4, Example 3, and Example 4.

FIG. 8 illustrates a relation between a magnetic field and a relative magnetic permeability of Comparative Example 1, Comparative Example 5, and Example 5.

FIG. 9 illustrates evaluation results of the composite magnetic material according to the embodiment.

FIG. 10 illustrates evaluation results of the composite magnetic material according to the embodiment.

FIG. 11 illustrates evaluation results of the composite magnetic material according to the embodiment.

### DESCRIPTION OF EMBODIMENT

### 1. Overview

An exemplary embodiment of the present disclosure will be described below. Note here that the following exemplary embodiment is just one of various exemplary embodiments of the present disclosure. The following exemplary embodiments can be modified in various ways depending on the design as long as the object of the present disclosure can be achieved.

A composite magnetic material according to the embodiment contains iron-based soft magnetic alloy particles, inorganic insulating particles, and a thermosetting resin. Surfaces of the inorganic insulating particles are coated with amphiphilic molecules each including a hydrophobic group and a hydrophilic group. The hydrophobic group includes a hydrocarbon chain. The hydrophilic group includes at least one of a phosphoric acid group and a phosphate salt.

The composite magnetic material according to the embodiment has a high withstand voltage while suppressing a decrease in relative magnetic permeability even when the composite magnetic material includes inorganic insulating particles as an electrically insulating component. A reason for this is presumed to be as follows. However, this exemplary embodiment is not restricted to the description of the reasons below.

Conventionally, an electrically insulating component added to a composite magnetic material tends to aggregate in a molded body, thereby reducing the filling rate of soft magnetic alloy particles. This result in decrease of relative magnetic permeability of the molded body. Furthermore, the aggregation of the electrically insulating component tends to reduce the withstand voltage. On the other hand, the inorganic insulating particles according to the embodiment are coated with amphiphilic molecules each including a hydrophobic group and a hydrophilic group. Specifically, on the surface of the inorganic insulating surface, the component of the surface of the inorganic insulating particles and at least one of the phosphoric acid group and a phosphate salt are bonded by acid-base interaction, and an amphiphilic molecule is adsorbed. Then, on the opposite side to the adsorbed side (that is, the side where the hydrophilic group is adsorbed) on the surface of the inorganic insulating particles, a hydrocarbon chain as a hydrophobic group, is present. Consequently, the inorganic insulating particles are less likely to aggregate. Since the inorganic insulating particles are less likely to aggregate and more likely to disperse in the molded body of the composite magnetic material, the filling rate of the iron-based soft magnetic alloy particles in the cured product of the composite magnetic material is easily increased. It is considered that a large filling rate of the iron-based soft magnetic alloy particles increases the rate of iron-based soft magnetic alloy particles that affect the magnetic force, and enhances the relative magnetic permeability. Furthermore, the inorganic insulating particles coated with amphiphilic molecules are interposed between the iron-based soft magnetic alloy particles while the inorganic insulating particles are less likely to aggregate in the cured product of the composite magnetic material. This increases the electrical resistivity of the cured product of the composite magnetic material. Thus, it is considered that the insulation resistance, that is, the withstand voltage, of the molded body produced from the composite magnetic material is increased.

The composite magnetic material according to the embodiment is cured to form a cured product, and, as described above, has high relative magnetic permeability and high withstand voltage, thus being suitably used for producing electronic components, for example, magnetic elements, such as a powder magnetic core, and a power choke coil.

### 2. Details

A composite magnetic material, a powder magnetic core, and a power choke coil according to the embodiment will be detailed below.

### (1) Composite Magnetic Material

As described above, the composite magnetic material according to the embodiment contains iron-based soft magnetic alloy particles, inorganic insulating particles, and a thermosetting resin. Details of the components that can be included in the composite magnetic material will be described.

### Iron-Based Soft Magnetic Alloy Particles

The iron-based soft magnetic alloy particles are electrically conductive. The iron-based soft magnetic alloy particles are dispersed in the composite magnetic material.

Iron-based soft magnetic alloy particles are soft magnetic alloy particles containing iron (Fe) as a main atom. The main atom refers to an atom with the highest mass proportion calculated by mass among atoms included in the soft magnetic alloy particle. For example, iron atoms preferably account for 50% by mass or more of the mass of all atoms included in the iron-based soft magnetic alloy particles.

The iron-based soft magnetic alloy constituting the iron-based soft magnetic alloy particles may be an alloy with an appropriate composition, and may include, for example, at least one atom selected from the group consisting of silicon (Si), chromium (Cr), and aluminum (Al) as an atom other than iron. However, the atoms other than iron are not limited to the above.

Soft magnetic alloy particles are particles obtained by sharing a soft magnetic alloy with soft magnetic property into particles. In the present disclosure, a soft magnetic alloy being particulate also includes being powdery. A particulate state of the soft magnetic alloy particles may be determined by measuring particle diameters and checking whether or not the particle diameters are 100 μm or less. The average particle diameter of the iron-based soft magnetic alloy particles in the present disclosure means the median diameter D50 (50% particle diameter). The average particle diameter of the iron-based soft magnetic alloy particles is obtained by measuring the particle size distribution of the iron-based soft magnetic alloy particles by a laser diffraction/scattering method and calculating a volume-based particle diameter in which an accumulation value becomes 50%. The average particle diameter of the iron-based soft magnetic alloy particles is, for example, 3 μm or more and 40 μm or less. The average particle diameter of the iron-based soft magnetic alloy particles within this range readily provides a high filling rate of the iron-based soft magnetic alloy particles in the molded body of the composite magnetic material. Furthermore, the average particle diameter of the iron-based soft magnetic alloy particles of 40 μm or less reduces a loss in the molded body (for example, a magnetic core) and particularly reduces an overcurrent loss even when the molded body made of the composite magnetic material is used in the high frequency band. Furthermore, the iron-based soft magnetic alloy particles may include alloy particles of particle groups each including a different particle size distribution. This configuration easily increases the filling rate of the iron-based soft magnetic alloy in the molded body of the composite magnetic material. As an example, the iron-based soft magnetic alloy particles may include alloy particles (A1) of a particle group with an average particle diameter of 3 μm or more and 20 μm or less, and alloy particles (A2) of a particle group with an average particle diameter of 20 μm or more and 40 μm or less. However, the average particle diameter of the iron-based soft magnetic alloy particles is not limited to the above.

Typical examples of the iron-based soft magnetic alloys include a soft magnetic iron-silicon (Fe—Si)-based alloy, a soft magnetic iron-aluminum (Fe—Al)-based alloy, a soft magnetic iron-aluminum-silicon (Fe—Al—Si)-based alloys, soft magnetic iron-silicon-chromium (Fe—Si—Cr)-based alloy, a soft magnetic iron-chromium (Fe—Cr)-based alloy, a soft magnetic iron-nickel (Fe—Ni)-based alloy, a soft magnetic iron-silicon-boron (Fe—Si—B)-based alloy, a soft magnetic iron-nitrogen (Fe—N)-based alloy, a soft magnetic iron-carbon (Fe—C)-based alloy, a soft magnetic iron-boron (Fe—B)-based alloy, a soft magnetic iron-phosphorus (Fe—P)-based alloy, Permendur (Fe—Co), soft magnetic iron-cobalt-vanadium (Fe—Co—V)-based alloy, a Fe-group amorphous alloy, and a Fe-based nanocrystalline alloy.

The proportion of the iron-based soft magnetic alloy particles with respect to the total solid content of the composite magnetic material is preferably 89% by mass or more and 99% by mass or less. The proportion of 89% by mass or more less decreases the saturation magnetic flux density when a molded body (for example, a magnetic core) is produced from the composite magnetic material. The proportion of 99% by mass or less allows the iron-based soft magnetic alloy particles to be easily bonded together, and easily maintains the shape of the magnetic core. In the present disclosure, the total solid content of the composite magnetic material refers to a total amount of components that can be included in the composite magnetic material, excluding volatile components such as solvents.

The iron-based soft magnetic alloy particles may be produced by any suitable methods, such as mechanical grinding, molten metal powdering, physical powdering, or chemical powdering. Examples of the mechanical grinding include, e.g., a stamp mill method, a ball mill method, and a hammer mill method. Examples of the molten metal powdering include, e.g., a high-pressure water spray method (water atomization method), an ultra-high-pressure water spray method, a gas spraying method (gas atomization method), a rotating electrode method, and a vacuum spray method. Examples of the physical or chemical powdering include an electrolysis method, a gas reduction method, a solid reduction method, a carbonyl method, a hydride decomposition method, an evaporation condensation method, and an amalgamation method. However, the method of producing iron-based soft magnetic alloy particles is not limited to the above-mentioned methods. Note here that the iron-based soft magnetic alloy particles may be previously surface-treated with, e.g., an appropriate dispersant or modifier.

### Inorganic Insulating Particles

Inorganic insulating particles are electrically insulating. Specifically, the inorganic insulating particles are made of an electrically insulating inorganic material. In accordance with the embodiment, surfaces of the inorganic insulating particles are coated with amphiphilic molecules each including a hydrophobic group and a hydrophilic group. Note here that the inorganic material does not include the above-mentioned iron-based soft magnetic alloy. In this exemplary embodiment, the entire surface of each of the inorganic insulating particles is coated with the amphiphilic molecules.

An amphiphilic molecule is a compound including a hydrophobic group and a hydrophilic group. In this exemplary embodiment, the hydrophobic group includes a hydrocarbon chain. The hydrophilic group includes at least one of a phosphoric acid group and a phosphate salt. The hydrocarbon chain in the hydrophilic group is a hydrocarbon group to which hydrocarbons are linked in a linear or branched manner. Note here that the amphiphilic molecule may further include a group other than the above-mentioned hydrocarbon group as a hydrophobic group, and may further include a group other than a phosphoric acid group and a phosphate salt as a hydrophilic group.

In the exemplary embodiment, the inorganic insulating particles may be interposed between the iron-based soft magnetic alloy particles in a cured product of composite magnetic material. In other words, the inorganic insulating particles may be dispersed in the cured product of the composite magnetic material so that iron-based soft magnetic alloy particles are less likely to contact each other. Therefore, in the cured product of the composite magnetic material, the inorganic insulating particles may contribute to increasing the withstand voltage.

In the present disclosure, the inorganic insulating particles being particulate also includes being powdery (powder). Furthermore, the average particle diameter of the inorganic insulating particles in the present disclosure means the median diameter D50 (50% particle size), the same as for the iron-based soft magnetic alloy particles. The average particle diameter of the inorganic insulating particles may be obtained by measuring the particle size distribution of the inorganic insulating particles by a laser diffraction/scattering method, and calculating a volume-based particle diameter in which an accumulation value becomes 50%. The average particle diameter of the inorganic insulating particles is preferably 0.8 μm or more and 4 μm or less. This configuration enhances the relative magnetic permeability and withstand voltage of the molded body.

The average particle diameter of the inorganic insulating particles and the average particle diameter of the iron-based soft magnetic alloy particles preferably satisfy the following relationship. That is, the ratio D_{Ins}/D_{Cond} of an average particle diameter D_{Ins} of the inorganic insulating particles to an average particle diameter D_{Cond} of the iron-based soft magnetic alloy particles preferably satisfies a relation of the following formula (1).

$$0.09 \leq {D}_{Ins} / {D}_{Cond} \leq 0.5 \qquad ( 1 )$$

The ratio D_{Ins}/D_{Cond} of 0.09 or more allows the inorganic insulating particles to enter and intervene between particles of the iron-based soft magnetic alloy particles in the cured product of the composite magnetic material. The filling rate of the alloy particles is further increased. Therefore, the relative magnetic permeability of the cured product is further increased. The ratio D_{Ins}/D_{Cond} of 0.5 or less maintains a high filling rate of iron-based soft magnetic alloy particles in the cured product of the composite magnetic material while increasing the withstand voltage. The ratio D_{Ins}/D_{Cond} is more preferably 0.2 or more. In the composite magnetic material, in the case that the volume of the iron-based soft magnetic alloy particles is 100 (% by volume), the proportion of the inorganic insulating particles with respect to the total volume of the iron-based soft magnetic alloy particles is preferably 1.3% by volume or more 4.0% by volume or less. The proportion of the inorganic insulating particles within the above range increases the filling property of the iron-based soft magnetic alloy particles in the composite magnetic material. Consequently, the relative magnetic permeability of the molded body of the composite magnetic material is further enhanced, and the withstand voltage is further increased.

The inorganic material constituting the inorganic insulating particles may be an inorganic component with appropriate insulating properties. The inorganic material includes at least one selected from the group consisting of, for example, talc (hydrated magnesium silicate), silica (silicon oxide), alumina (aluminum oxide), boron nitride, magnesium oxide, titanium oxide, zirconium oxide, and mica. The boron nitride preferably includes hexagonal boron nitride (h-BN).

The inorganic insulating particles with surfaces coated with amphiphilic molecules in the present disclosure may be produced, for example, as follows. However, the method for producing inorganic insulating particles with surfaces coated with amphiphilic molecules is not limited to the method below.

Electrically insulative particulate inorganic material as inorganic insulating particles, and a dispersant, are prepared.

The dispersant contains the above-mentioned amphiphilic molecules. For this reason, it is particularly easy to coat the surfaces of the inorganic insulating particles with the amphiphilic molecules. The dispersant is preferably, for example, a phosphate ester-based dispersant. A phosphate ester-based dispersant includes amphiphilic molecules, the hydrophobic group includes a hydrocarbon chain, and the hydrophilic group includes at least one of a phosphoric acid group and a phosphate salt. More specifically, the dispersant is, for example, a phosphate ester-based wetting dispersant.

Subsequently, the inorganic insulating particles, the dispersant, and, a solvent, such as an organic solvent, if necessary, are mixed to disperse the inorganic insulating particles in the mixture. In this case, the proportion of the amphiphilic molecules with respect to 100% by mass of the inorganic insulating particles is preferably 10% by mass or more and 100% by mass or less. The proportion of the amphiphilic molecules of 10% by mass or more allows the molded body of the composite magnetic material to maintain a high relative magnetic permeability and improve the withstand voltage. The proportion of the amphiphilic molecules of 100% by mass or less allows the surfaces of the inorganic insulating particles to be coated with sufficient amounts of the amphiphilic molecules, hence providing particularly excellent relative magnetic permeability and withstand voltage. The proportion of the amphiphilic molecules is more preferably 30% by mass or more. The upper limit of the proportion of the amphiphilic molecules is not particularly limited, and is, for example, 100% by mass.

As a result, inorganic insulating particles coated with amphiphilic molecules are obtained.

### Thermosetting Resin

A thermosetting resin functions as a so-called binder (binding agent) in a cured product of a composite magnetic material. That is, the thermosetting resin has a function of binding the iron-based soft magnetic alloy particles to each other in the cured product of the composite magnetic material. However, in this exemplary embodiment, as described above, since inorganic insulating particles are interposed between the iron-based soft magnetic alloy particles in the cured product of the composite magnetic material, the binding is not limited to the binding of all the iron-based soft magnetic alloy particles each other.

Thermosetting resin is electrically insulative. When the composite magnetic material is cured, the thermosetting resin enters to fill gaps between the soft magnetic alloy particles. Therefore, the electrical insulation properties of the molded body of composite magnetic material can be enhanced. Furthermore, the thermosetting resin can ensure moldability in producing a cured product by molding a composite magnetic material.

Examples of the thermosetting resins include, but are not limited to, epoxy resins, phenolic resins, phenoxy resins, silicone resins, polyimides, and organic phosphate compounds.

Examples of epoxy resins include one or more components selected from the group consisting of alkylphenol novolac type epoxy resins such as phenol novolac type epoxy resin and cresol novolac type epoxy resin; naphthol novolac type epoxy resins; phenol aralkyl type epoxy resin including a phenylene skeleton, a biphenylene skeleton, and the like; biphenyl aralkyl type epoxy resins; naphthol aralkyl type epoxy resins including a phenylene skeleton, a biphenylene skeleton, and the like; multifunctional epoxy resins such as triphenol methane type epoxy resins and alkyl modified triphenol methane type epoxy resins; triphenyl methane type epoxy resins; tetrakisphenol ethane type epoxy resins; dicyclopentadiene-type epoxy resin; stilbene-type epoxy resin; bisphenol type epoxy resin such as bisphenol A type epoxy resin and bisphenol F type epoxy resin; biphenyl epoxy resin; naphthalene-type epoxy resin; alicyclic epoxy resin; bromine-containing epoxy resins such as bisphenol A type bromine-containing epoxy resins; glycidylamine-type epoxy resin obtained by reaction of polyamine such as diaminodiphenylmethane and isocyanuric acid with epichlorohydrin; and glycidyl ester-type epoxy resins obtained by the reaction of a polybasic acid such as phthalic acid or dimer acid with epichlorohydrin.

The thermosetting resin may be in, for example, a liquid state or a solid state.

The composite magnetic material may contain a curable component other than the thermosetting resin. For example, the composite magnetic material may contain a photocurable component.

The proportion of the thermosetting resin with respect to the total amount of iron-based soft magnetic alloy particles may be adjusted as appropriate depending on the shape of the composite magnetic material, the type of thermosetting resin, and the properties required for the molded body, but is, for example, 1% by mass or more and 10% by mass or less. The proportion within this range easily maintains preferable electrical insulation of the molded body of the composite magnetic material.

The composite magnetic material may contain components other than those described above unless otherwise deviating from a purpose of the present disclosure. For example, the composite magnetic material may contain additives as components other than those described above. Examples of the additives include, e.g., modifiers, lubricants, and hardeners.

The modifier or lubricant improves the dispersibility of the iron-based soft magnetic alloy particles in the cured product of the composite magnetic material, or modifies the surfaces of the iron-based soft magnetic alloy particles. Examples of the modifier include coupling agents and surfactants. Examples of the coupling agent include at least one component selected from the group consisting of a silane coupling agent, a titanium-based coupling agent, a titanium alkoxide, and a titanium chelate. Examples of the surfactant include ionic surfactants and nonionic surfactants.

Furthermore, as the lubricant may be, for example, an organometallic soap. Examples of the organometallic soap include at least one component selected from the group consisting of zinc stearate, calcium stearate, magnesium stearate, and barium stearate. Note here that the modifier and the lubricant are not limited to the above-mentioned components.

The curing agent is not particularly limited as long as it is a component capable of curing the thermosetting resin. Note here that in the present disclosure, the curing agent also includes a curing accelerator, a curing catalyst, and a curing assistant. Typical examples of the curing agent include phenol-based curing agents, acid anhydride-based curing agents, aliphatic amine-based curing agents, and aromatic amine-based curing agents, as well as imidazole-based curing accelerators, tertiary amines, and phosphorus compounds.

### (2) Preparation of Composite Magnetic Material and Molded Body

The composite magnetic material according to the embodiment may be prepared, for example, as follows.

First, iron-based soft magnetic alloy particles, inorganic insulating particles with surfaces coated with amphiphilic molecules (hereinafter, also referred to as “coated inorganic insulating particles”), and a thermosetting resin are provided. The iron-based soft magnetic alloy particles may be previously surface-treated, if necessary, with, e.g., an appropriate dispersant, a modifier, and a lubricant.

Then, the iron-based soft magnetic alloy particles and the coated inorganic insulating particles are put in, for example, a container in which the particles as kneaded and mixed, and the mixed product is uniformly dispersed.

Subsequently, the iron-based soft magnetic alloy particles and the coated inorganic insulating particles are mixed, then the thermosetting resin is further added, and additives, solvents, and the like, if necessary, are further added, and the resulting mixture is kneaded. In adding the thermosetting resin, the thermosetting resin may be added to the iron-based soft magnetic alloy particles and the coated inorganic insulating particles while the resulting mixture is previously dissolved in a solvent. Furthermore, in the kneading, an appropriate kneading device may be used. The kneading conditions may be appropriately adjusted depending on, e.g., the type of thermosetting resin and the melting start temperature. However, for example, the heating temperature may be set to a temperature lower than the temperature at which the thermosetting resin starts to be cured. Thus, a composite magnetic material is obtained.

Furthermore, by heating the kneaded composite magnetic material at an appropriate temperature, the composite material may also be dried. When a solvent such as an organic solvent is added during kneading, drying is preferably carried out by heating at a temperature at which the solvent can volatilize.

Furthermore, the dried composite magnetic material may be pulverized with an appropriate pulverizing device to make the composite magnetic material in powder shape. The pulverization may be carried out by a stamp mill method, a ball mill method, or a hammer mill method. The composite magnetic material may be pulverized and then further classified to produce a composite magnetic material with an appropriate particle diameters. The particle diameters of the composite magnetic material may be, for example, 100 μm or more and 500 μm or less, but is not limited to this.

Thus, the shape or properties of the composite magnetic material are not particularly limited. The composite magnetic material in powdery (powder body) enhances moldability. Therefore, the powder body of the composite magnetic material can be suitably used as a material for producing, for example, a molded body. To produce a molded body, first, the composite magnetic material of the powder body is put into a mold and pressure-molded into an appropriate shape. The conditions for pressing may be appropriately adjusted, and may be, for example, 1 ton/cm² or more and 10 ton/cm² or more.

Subsequently, the composite magnetic material after pressure molding is heated to cure the thermosetting resin. Conditions such as heating temperature and heating time may be adjusted appropriately depending on, e.g., the type of thermosetting resin, but the heating temperature is, for example, 150° C. or more and 300° C. or less, and the heating time is 1 minute or more and 10 hours or less.

A cured product of the composite magnetic material may be obtained. Note here that in the present disclosure, a molded body of a composite magnetic material includes a cured product of the composite magnetic material.

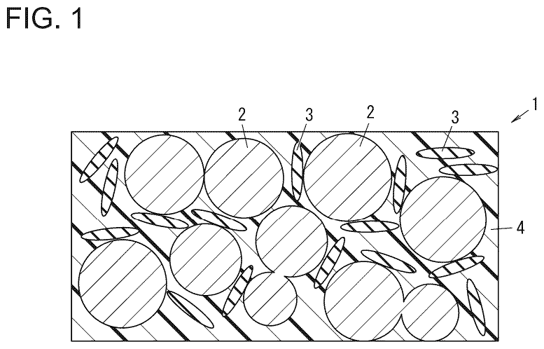

FIG. 1 is a schematic sectional view of molded body 1 produced from the composite magnetic material according to the embodiment. As shown in FIG. 1, molded body 1 contains iron-based soft magnetic alloy particles 2, inorganic insulating particles 3, and a cured product 4 of thermosetting resin. That is, molded body 1 includes the composite magnetic material described above. Inorganic insulating particles 3 are interposed between iron-based soft magnetic alloy particles 2. The surfaces of the inorganic insulating particles 3 are coated with amphiphilic molecules each including a hydrophobic group with a hydrocarbon chain and a hydrophilic group that is at least one of a phosphoric acid group and a phosphate salt. Therefore, the molded body including the composite magnetic material enhances the withstand voltage while suppressing a decrease in relative magnetic permeability.

### Characteristics of Molded Product and Cured Product

The initial relative magnetic permeability of a cured product of the composite magnetic material is a relative magnetic permeability when no magnetic field is applied (that is, magnetic field is 0 kA/m). The initial relative magnetic permeability of the composite magnetic material and the relative magnetic permeability when a magnetic field is applied in the present disclosure can be measured and calculated by the method in Example “(2-1) Evaluation 1: Initial relative magnetic permeability and relative magnetic permeability” described later.

The withstand voltage of the cured product of the composite magnetic material is preferably 70 V/mm or more. In this case, when the cured product produced from the composite magnetic material is used as the magnetic core of an inductor component, leakage current of the magnetic core can be effectively reduced. The withstand voltage of the cured product in the present disclosure may be measured and calculated by the method in Example “(2-2) Evaluation 2: Withstand voltage” described later.

As described above, the composite magnetic material according to the embodiment enhances both the relative magnetic permeability and the withstand voltage of the molded body even when the composite magnetic material includes an electrically insulating component. For this reason, the composite magnetic material of this exemplary embodiment may be suitably used for manufacture magnetic elements and magnetic cores that are to be provided in the magnetic elements, for example, by applying pressure and molding the composite magnetic material into a desired shape.

For example, the composite magnetic materials may be used to manufacture magnetically responsive electronic components, for example, inductor components that are magnetic elements. The inductor components include inductors, noise filters, reactors, and transformers. Furthermore, applications of uses of the magnetic elements are not particularly limited, but include, for example, noise filter components, impedance matching circuit components, and the like. Examples of the inductor component include a coil-shaped conductor part and a coating layer that coats the coil-shaped conductor part. Therefore, an inductor component can be produced with a molded body made of the composite magnetic material as the coating layer. In particular, molded body 1 of the composite magnetic material of this exemplary embodiment may be suitably used for powder magnetic core 10, power choke coils 110, and the like. However, it is not intended that the applications of uses of the composite magnetic material are limited to those described above.

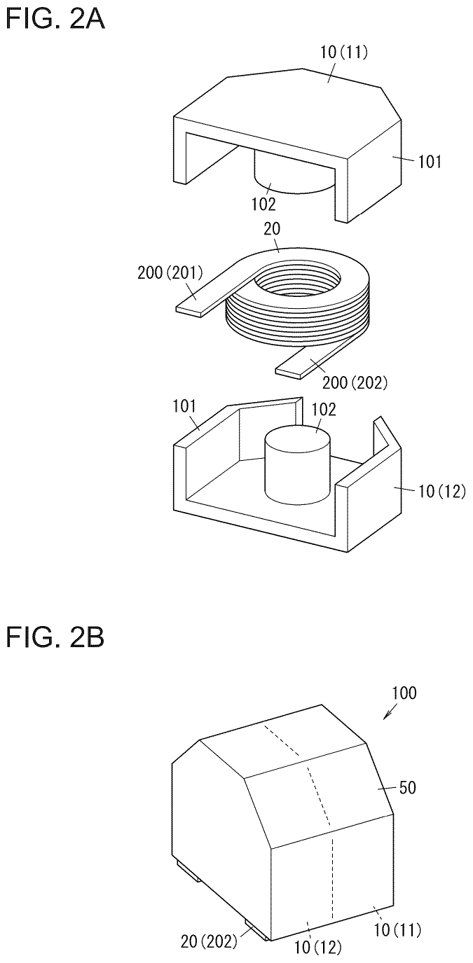

Preferable aspects of powder magnetic core 10 and power choke coil 110 of this exemplary embodiment are described with reference to the drawings (FIGS. 2A to 4).

### (3) Powder Magnetic Core

Powder magnetic core 10 is used, for example, for a magnetic element including a magnetic core. Powder magnetic core 10 is also called a dust core.

Powder magnetic core 10 includes molded body 1 (cured product) of the composite magnetic material described above. Powder magnetic core 10 of this exemplary embodiment is a molded body obtained by, for example, pressure molding and heating the composite magnetic material described above.

The shape of powder magnetic core 10 may be determined according to appropriate shapes for use in electronic components such as magnetic elements, and is not particularly limited, but may be, for example, a cylindrical shape, a polygonal prism shape, a toroidal shape, and a disk shape.

Specifically, powder magnetic core 10 shown as an example in FIG. 2A is molded to include protrusion 102 and main body 101. Protrusion 102 passes through an air core of conductor part 20 about which a copper wire is wound so as to include the air core. Main body 101 covers the circumference of the wound part of coil conductor 20. In FIG. 2A, coil conductor 20 is an edgewise coil formed by, for example, winding a rectangular copper wire, but is not limited to this.

FIG. 2A is an exploded perspective view of choke coil 100 for illustrating coil conductor 20 sandwiched between two same-shaped powder magnetic cores 10 (11, 12) in upward and downward directions along the air core of coil conductor 20. Each of powder magnetic cores 10 (11, 12) includes protrusion 102 to pass through the air core. That is, choke coil 100 is produced with coil conductor 20 and powder magnetic cores 10 (11,12) (see FIG. 2B). Tip ends 200 (first tip end 201 and second tip end 202) of coil conductor 20 sandwiched between powder magnetic cores 11 and 12 may protrude outward from powder magnetic cores 11 and 12 when powder magnetic cores 11 and 12 are stacked on each other. First tip end 201 and second tip end 202 may become terminals (connection terminals) configured to be connected to an external circuit. The connection terminals may be produced by causing powder magnetic cores 11 and 12 to sandwich coil conductor 20, then stacking them, and then bending tip parts 201 and 202 of coil conductor 20 in directions opposite to each other. As shown in FIG. 2B, case 50 may be formed by sandwiching coil conductor 20 between powder magnetic cores 11 and 12 and stacking them, and then molding with resin to cover the entire main body part 101 of powder magnetic core 10 (11 and 12).

### (4) Power Choke Coil

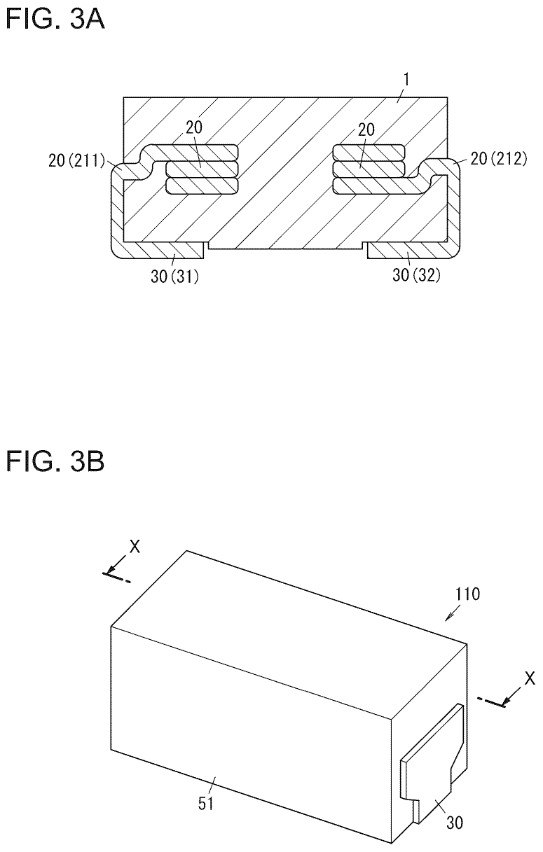

A power choke coil is a passive element configured to store electric energy flowing between terminal parts as magnetic energy. Power choke coil 110 includes, for example, coil conductor 20. Coil conductor 20 includes two terminal parts (first end 211 and second end 212) (see FIG. 3A). Power choke coil 110 is configured to generate magnetic energy with a current flowing between first terminal 211 and second terminal part 212 of coil conductor 20. Coil conductor 20 is, for example, an edgewise coil formed by winding a rectangular copper wire.

As described above, the composite magnetic material provides high relative magnetic permeability and high withstand voltage to molded body 1, and therefore, is suitably used for producing power choke coil 110. Power choke coil 110 according to the embodiment includes the cured product of the composite magnetic material and coil conductor 20. Coil conductor 20 is covered with the cured product of the composite magnetic material. Note here that the cured product of the composite magnetic material is molded body 1 of a composite magnetic material, and therefore, may be the above-mentioned powder magnetic core 10.

Choke coil 100 shown in FIG. 2B may be a type of power choke coil 110, but in power choke coil 110 shown in FIGS. 3A to 3B, the composite magnetic material and coil conductor 20 are molded integrally with each other. Specifically, as shown in the sectional view of FIG. 3A, in power choke coil 110, since coil conductor 20 is coated with the composite magnetic material and molded, coil conductor 20 is incorporated inside molded body 1. In other words, choke coil 100 shown in FIGS. 2A to 2B is a coil-assembled magnetic element in which the composite magnetic material molded body (powder magnetic core 10) and coil conductor 20 are provided separately and assembled, whereas power choke coil 110 shown in FIGS. 3A to 3B may be considered to be a coil-embedded magnetic element in which the composite magnetic material and coil conductor 20 are integrally molded so as to include coil conductor 20.

As shown in FIGS. 3A and 3B, power choke coil 110 includes coil conductor 20 with an air core inside molded body 1, and may be used for applications where a large current flows, and also can be reduced in size.

Coil conductor 20 includes first end 211 and second end 212. First end 211 and second end 212 are connected to respective connection terminals 30. Specifically, first end 5211 is connected to first connection terminal 31, and second end 212 is connected to second connection terminal 32. Furthermore, an air core of coil conductor 20 is filled with a cured product of the composite magnetic material (molded body 1), therefore, a section that has been an air core of coil conductor 20 can serve as a magnetic path.

Connection terminals 30 (first connection terminal 31 and second connection terminal 32) are configured to be connected to external electrodes, thereby allowing an electric current to a flow through power choke coil 110. An electric current flowing through power choke coil 110 generates a magnetic field. When the magnetic path includes molded body 1 of the composite magnetic material, the relative magnetic permeability is less likely to decrease, and power choke coil 110 effectively converts electrical energy into magnetic energy and store the magnetic energy. Power choke coil 110 is also has a high withstand voltage.

Note here that as shown in FIG. 3B, housing 51 may be formed by mold-molding outer surfaces of the cured product of the composite magnetic material (molded body 1) and outer surfaces of first end 211 and second end 212 of coil conductor 20 with an appropriate resin.

### Modification

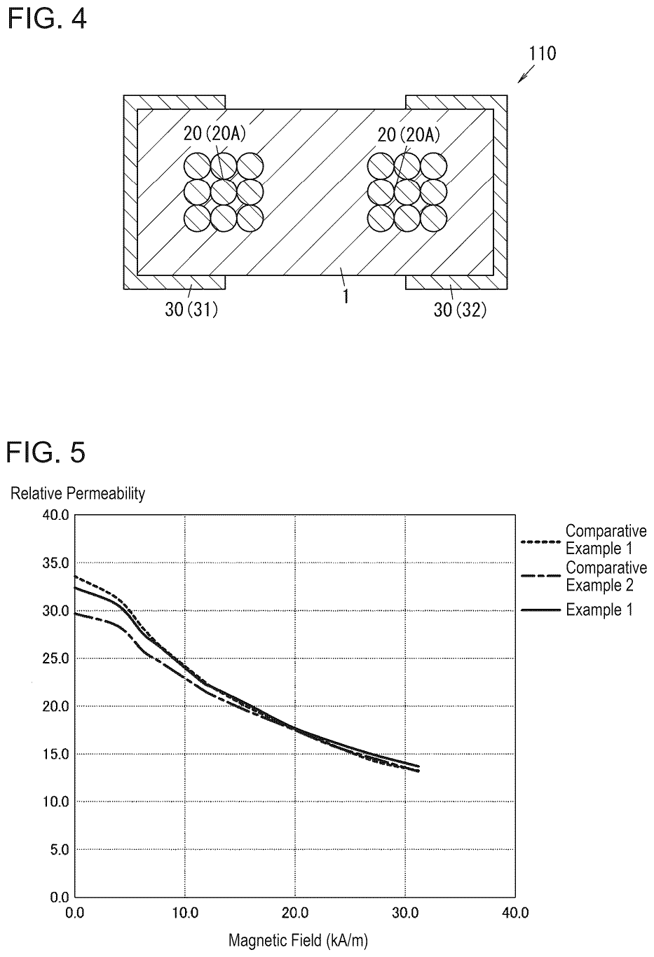

Power choke coil 110 shown in FIG. 4 is also a coil-embedded magnetic element in which a composite magnetic material and coil conductor 20 are integrally molded, similar to those in FIGS. 3A and 3B. In power choke coil 110 shown in FIG. 4, for example, a coil wire, specifically, winding coil 20A, is used as coil conductor 20. In power choke coil 110, winding coil 20A and a composite magnetic material are integrally molded. Winding coil 20A includes a first end and a second end (not shown), and the first end and the second end of winding coil 20A are connected to connection terminals 30, respectively, so that a current may flow through power choke coil 110. In power choke coil 110 of this modification, relative magnetic permeability is less reduced, and excellent withstand voltage is achieved.

### (5) Summary

As is apparent from the above-described exemplary embodiment, the present disclosure includes the following aspects. In the following, reference symbols are given in parentheses only to clarify the correspondence with the embodiment.

A composite magnetic material according to a first aspect contains iron-based soft magnetic alloy particles, inorganic insulating particles, and a thermosetting resin. Surfaces of the inorganic insulating particles are coated with amphiphilic molecules each including a hydrophobic group and a hydrophilic group. The hydrophobic group includes a hydrocarbon chain. The hydrophilic group includes at least one of a phosphoric acid group and a phosphate salt.

According to this aspect, the relative magnetic permeability of the molded body can be reduced and the withstand voltage can be improved.

In a composite magnetic material in the first aspect according to a second aspect, an average particle diameter D_{Ins} of the inorganic insulating particles and an average particle diameter D_{Cond} of the iron-based soft magnetic alloy particles satisfy a relation of formula (1).

$$0.09 \leq {D}_{Ins} / {D}_{Cond} \leq 0.5 \qquad ( 1 )$$

According to this aspect, the relative magnetic permeability of the molded body is further enhanced, and the withstand voltage is further increased.

In a composite magnetic material in the first or second aspect according to a third aspect, the average particle diameter of the inorganic insulating particles is 0.8 μm or more and 4 μm or less.

According to this aspect, the relative magnetic permeability and withstand voltage of the molded body can be further improved.

In a composite magnetic material in any one of the first to third aspects according to a fourth aspect, a volume proportion of the inorganic insulating particles with respect to the total volume of the iron-based soft magnetic alloy particles is 1.3% by volume or more and 4.0% by volume.

According to this aspect, the molded body maintains a high relative magnetic permeability, has a high withstand voltage.

In a composite magnetic material in any one of the first to fourth aspects according to a fifth aspect, the proportion of the amphiphilic molecules with respect to the total mass of the inorganic insulating particles is 10% by mass or more and 100% by mass or less.

According to this aspect, the molded body of the composite magnetic material maintains a high relative magnetic permeability and further improves the withstand voltage. Furthermore, the proportion of amphiphilic molecules of 100% by mass or less allows the surfaces of the inorganic insulating particles to be coated with sufficient amounts of amphiphilic molecules, hence providing preferable relative magnetic permeability and withstand voltage.

In the composite magnetic material in any one of the first to fifth aspects according to a sixth aspect, the inorganic insulating particles include a coated particle obtained by adding 10% by mass or more and 100% by mass or less of the amphiphilic molecule to 100% by mass of the inorganic insulating particles.

According to this aspect, the molded body of the composite magnetic material maintains a high relative magnetic permeability and has a preferable withstand voltage. The proportion of amphiphilic molecules of 100% by mass or less allows the surfaces of the inorganic insulating particles coated with sufficient amounts of the amphiphilic molecules, hence providing a preferable relative magnetic permeability and withstand voltage.

A powder magnetic core (10) according to a seventh aspect includes a cured product of the composite magnetic material according to any one of the first to sixth aspects.

This aspect provides powder magnetic core (10) having the relative magnetic permeability less likely to decrease and concurrently having a high withstand voltage.

A power choke coil (110) according to an eighth aspect includes a cured product of the composite magnetic material according to any one of the first to sixth aspects and a coil conductor (20). The coil conductor (20) is covered with the cured product of the composite magnetic material.

This aspect makes provides a powder magnetic core (110) having the relative magnetic permeability less likely to decrease and concurrently having a high withstand voltage.

### EXAMPLE

The present disclosure will be specifically described below with reference to Examples. However, the present disclosure is not limited to the following Examples.

### (1) Experiment 1 (Preparation of Composite Magnetic Material)

### Comparative Example 1

As iron-based soft magnetic alloy particles (hereinafter, also referred to as “alloy particles”), Fe—Si —Cr-based metal powder (FeSiCr-based metal powder) with an average particle diameter D50 of 9 μm was provided. 4% by mass of epoxy resin as a thermosetting resin and MEK (methyl ethyl ketone) as an organic solvent were mixed to 100% by mass of the provided alloy particles. In Comparative Example 1, no inorganic insulating particles were added. The mixed product was kneaded and then dried at 50° C. for 30 minutes to remove the solvent, thereby preparing a composite magnetic material (dried product).

The dried material was pulverized with a pulverizer and classified to obtain powder of composite magnetic material with particle diameters ranging from 100 μm to 500 μm.

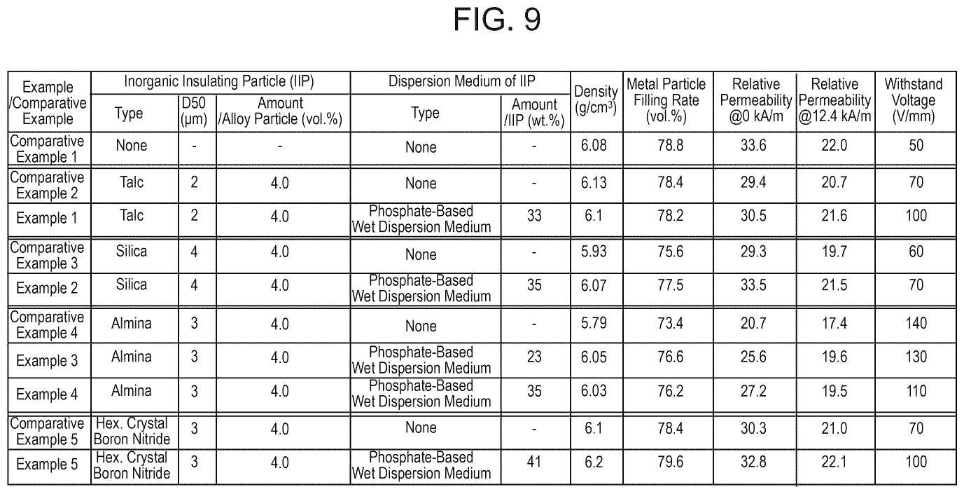

Subsequently, the powder was put into a compression molding die and molded under a pressure of 2 t/cm². Note here that for the evaluation described below, a toroidal shaped molded body and a disk-shaped molded body were produced as quasi-test pieces. Subsequently, the molded bodies of each quasi-test piece were heated at 175° C. for 3 hours to be cured, thereby producing a cured product of the composite magnetic material. Thus, a toroidal shaped cured test piece and a disk-shaped cured test piece were obtained. The density of the test piece of the cured product and the filling rate (% by volume) of the alloy particles are shown in FIG. 9 as “density (g/cm³)” and “alloy particle filling rate (% by volume)”, respectively. Note here that the density of the cured test piece was calculated by dividing the mass of the test piece by the volume of the test piece measured with a micrometer. The filling rate of the alloy particles was calculated from the following formula (2). The same applies below. In the following formula (2), the density of the test piece is represented by d_{Mea}, the true density of the alloy particles is represented by d_{Met}, the true density of the inorganic insulating particles is represented by d_{Ins}, the true density of the thermosetting resin is represented by d_{Res}, the filling rate of the alloy particles is represented by a_{Met}, the % by mass of the inorganic insulating particles is Mins, the % by mass of the thermosetting resin is represented by M_{Res}, and the % by mass of the amphiphilic molecules is represented by M_{Amp}, with respect to 100% by mass of the alloy particles in the composite magnetic material.

$${a}_{Met} = {d}_{M e a} \times ( 100 / {d}_{M e t} ) / ( 100 + {M}_{Ins} + {M}_{Res} + {M}_{A m p} ) \times 100 \qquad ( 2 )$$

### Example 1, Comparative Example 2

In Example 1, FeSiCr-based metal powder with an average particle diameter (D50) of 9 μm was provided as alloy particles. Talc with an average particle diameter (D50) of 2 μm was provided as the inorganic insulating particles. 33% by mass of phosphate ester-based wetting dispersant and MEK as an organic solvent were added to 100% by mass of the inorganic insulating particles and stirred to subject the inorganic insulating particles to a surface treatment to prepare coated inorganic insulating particles.

Subsequently, the alloy particles and the coated inorganic insulating particles were mixed to each other, and then, 4% by mass of epoxy resin as a thermosetting resin and MEK as an organic solvent were mixed to 100% by mass of the alloy particles. Then, the mixture was kneaded and dried at 50° C. for 30 minutes to remove the solvent, thus preparing a composite magnetic material (dried material). The dried material was pulverized by a pulverizer, and then classified to obtain powder of the composite magnetic material with a particle diameter ranging from 100 μm to 500 μm.

In Comparative Example 2, the inorganic insulating particles were talc as in Example 1, but the inorganic insulating particles were not subject to a surface treatment. The powder of the composite magnetic material with a particle diameter ranging from 100 μm to 500 μm was obtained by mixing, kneading, drying, pulverizing, and classifying it in the same manner as in Example 1 except for the above.

Subsequently, for powder of each of the composite magnetic materials of Example 1 and Comparative Example 2, the powder was compression-molded under the same conditions as in Comparative Example 1 to produce a toroidal shaped molded body and a disk-shaped molded body as quasi-test pieces, and the molded bodies as the quasi-test pieces were heated at 175° C. for 3 hours to be cured. Thus, a toroidal shaped cured product test piece and a disk-shaped cured product test piece were obtained. The densities of the test pieces of the cured product and the filling rates (% by volume) of the alloy particles are as shown in FIG. 9.

### Example 2, Comparative Example 3

In Example 2, powder of a composite magnetic material was produced in the same conditions as in Example 1 except that the inorganic insulating particles in Example 1 were changed to silica with an average particle diameter D50 of 4 μm, and the amount of the phosphate ester-based wetting dispersant used in surface treating of the inorganic insulating particles was changed to 35% by mass.

In Comparative Example 3, powder of a composite magnetic material was produced in the same conditions as in Comparative Example 2 except that the inorganic insulating particles in Comparative Example 2 were changed to silica with an average particle diameter D50 of 4 μm.

Subsequently, for powder of each of the composite magnetic materials of Example 2 and Comparative Example 3, the powder were compression-molded under the same conditions as in Comparative Example 1 to produce a toroidal shaped molded body and a disk-shaped molded body as quasi-test pieces, and the molded bodies as the quasi-test pieces were heated at 175° C. for 3 hours to be cured. Thus, a toroidal shaped cured product test piece and a disk-shaped cured product test piece were obtained. The densities of the test pieces of the cured product and the filling rates (% by volume) of the alloy particles are as shown in FIG. 9.

### Examples 3-4, Comparative Example 4

In Example 3, powder of a composite magnetic material was produced in the same conditions as in Example 1 except that inorganic insulating particles of Example 1 was changed to alumina with an average particle diameter D50 of 3 μm, and an amount of the phosphate ester-based wetting dispersant in surface treating the inorganic insulating particles was changed to 23% by mass.

In Example 4, powder of a composite magnetic material was produced in the same conditions as in Example 3 except that an amount of the phosphate ester-based wetting dispersant in Example 3 was changed to 35% by mass.

In Comparative Example 4, powder of a composite magnetic material was produced in the same conditions as in Comparative Example 2 except that inorganic insulating particles of Comparative Example 2 were changed to alumina with an average particle diameter D50 of 3 μm.

Subsequently, for powder of each of the composite magnetic materials of Examples 3-4 and Comparative Example 4, the powder was compression-molded under the same conditions as in Comparative Example 1 to produce a toroidal shaped molded body and a disk-shaped molded body as quasi-test pieces, and the molded bodies as the quasi-test pieces were heated at 175° C. for 3 hours to be cured. Thus, a toroidal shaped cured product test piece and a disk-shaped cured product test piece were obtained. The densities of the test pieces of the cured product and the filling rates (% by volume) of the alloy particles are as shown in FIG. 9.

### Example 5, Comparative Example 5

In Example 5, powder of a composite magnetic material was produced in the same conditions as in Example 1 except that the inorganic insulating particles in Example 1 were changed to boron nitride (hexagonal boron nitride) with an average particle diameter D50 of 3 μm, and an amount of the phosphate ester-based wetting dispersant used in surface treating the inorganic insulating particles was changed to 41% by mass.

In Comparative Example 5, powder of a composite magnetic material was produced in the same conditions as in Comparative Example 2 except that the inorganic insulating particles in Comparative Example 2 were changed to boron nitride (hexagonal boron nitride) with an average particle diameter D50 of 3 μm.

Subsequently, for powder of each of the composite magnetic materials of Example 5 and Comparative Example 5, the powder was compression-molded under the same conditions as in Comparative Example 1 to produce a toroidal shaped molded body and a disk-shaped molded body as quasi-test pieces, and the molded bodies as the quasi-test pieces were heated at 175° C. for 3 hours to be cured. Thus, a toroidal shaped cured product test piece and a disk-shaped cured product test piece were obtained. The densities of the test pieces of the cured product and the filling rates (% by volume) of the alloy particles are as shown in FIG. 9.

### (2) Evaluation of Experiment 1

### (2-1) Evaluation 1: Initial Relative Magnetic Permeability and Relative Magnetic Permeability

In each of Examples and Comparative Examples, a silver-plated soft copper wire with a diameter of 0.6 mm and a coating thickness of 0.15 mm was wound 30 times around a test piece of a toroidal-shaped molded body with dimensions of an outer diameter of 14 mm, an inner diameter of 10 mm, and a thickness of about 2 mm, and then connected to an LCR meter, and the inductance was measured at a current of 0 A under a condition of 10 kHz. From the obtained results, the relative magnetic permeability was calculated based on the following formula (3). In formula (3), L represents inductance [H], μ0 represents a magnetic permeability [H/m] in vacuum, μi represents a relative magnetic permeability, le represents a magnetic path length [m], Ae represents a cross-sectional area [m²], and n represents a number of windings of a coil, and letters in [ ] are units. The values thus calculated are shown in FIG. 9.

$$L = ( μ i ) \times ( μ 0 ) \times {n}^{2} \times Ae / le \qquad ( 3 )$$

Subsequently, in order to measure the inductance when a magnetic field was applied, a direct-current (DC) bias current was applied to the above-mentioned test piece around which a copper wire had been wound under the same conditions, and the inductance was measured at 10 kHz with an LCR meter as in the initial relative magnetic permeability.

Note here that the DC current required for the applied magnetic field was calculated based on the following formula (4). In formula (4), Hx represents an applied magnetic field [A/m], le represents a magnetic path length [m], Ix represents an applied current [A], and n represents the number of windings of the coil, and the words in [ ] are units.

$$Hx = n / le \times Ix \qquad ( 4 )$$

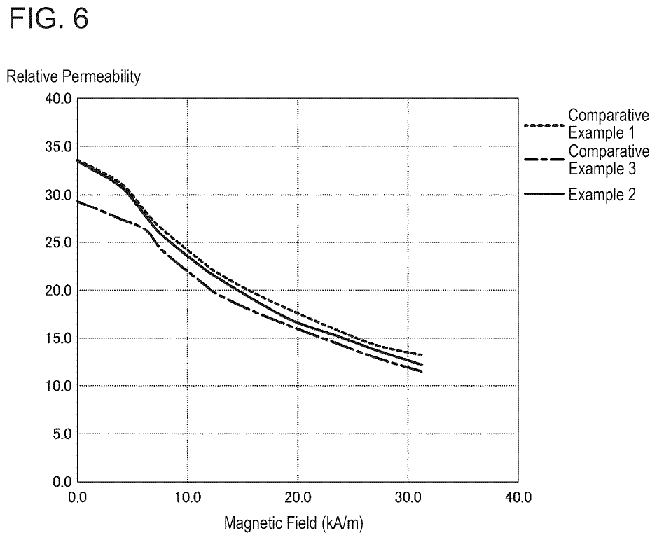

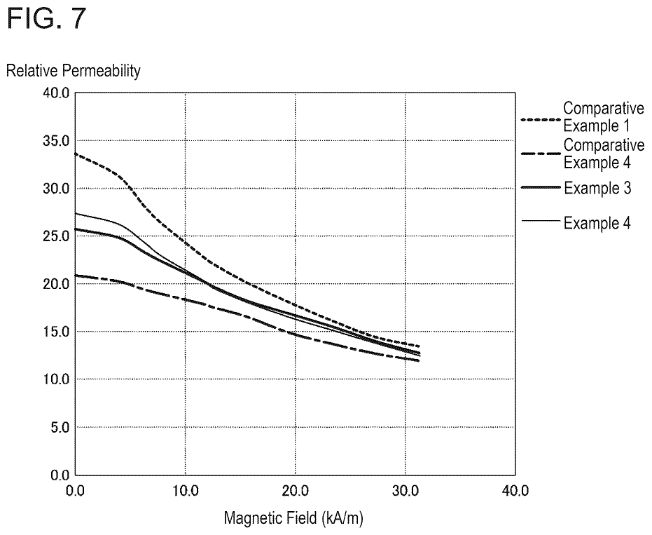

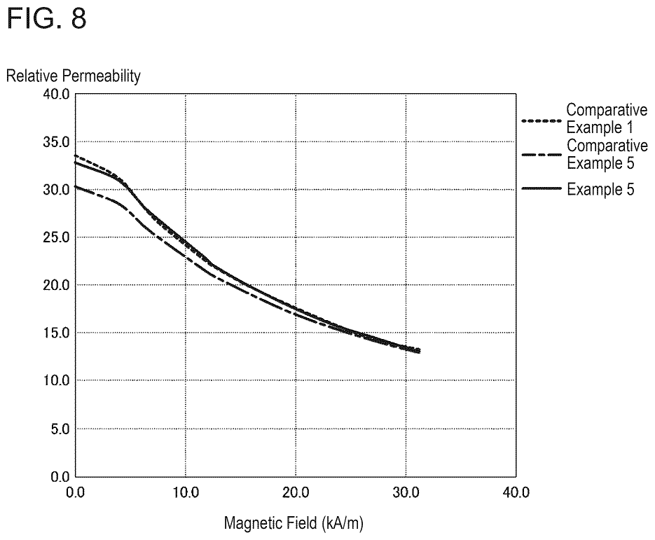

FIG. 9 shows a relative magnetic permeability when no magnetic field is applied (0 kA/m) (also referred to as an initial relative magnetic permeability) and a relative magnetic permeability when the magnetic field is 12.4 kA/m. FIGS. 5 to 8 illustrate a relation between the applied magnetic field and the relative magnetic permeability. In FIGS. 5 to 8, the horizontal axis represents a magnetic field [kA/m], and the vertical axis represents a relative magnetic permeability. FIG. 5 shows the results of Comparative Examples 1 and 2, and Example 1. FIG. 6 shows the results of Comparative Examples 1 and 3, and Example 2. FIG. 7 shows the results of Comparative Examples 1 and 4, and Examples 3 and 4. FIG. 8 shows the results of Comparative Examples 1 and 5, and Example 5.

### (2-2) Evaluation 2: Withstand Voltage

In each of Examples and Comparative Examples, both surfaces of a test piece of a disk-shaped cured product with a diameter of 12 mm and a thickness of about 1 mm near the center thereof were sandwiched by probes, and a DC voltage of 10 V was applied in stages using an ultra-high resistance/micro ammeter. The discharge time was 1 second, and the charge time was 10 seconds. From the “voltage [V] at the time when the leakage current became 10 mA or more” obtained from the above, the withstand voltage was calculated based on the following formula (5). In formula (5), Ex represents a withstand voltage [V/mm], Ez represents a “voltage at the time when a leakage current became 10 mA or more” [V], d represents a thickness [mm] of the test piece, and the letters in [ ] are units. The results are shown in the “Withstand voltage (V/mm)” column in FIG. 9.

$$Ex = ( E z - 10 ) / d \qquad ( 5 )$$

As is apparent from the above results, when comparing Comparative Example 1 in which no inorganic insulating particles were added with Comparative Examples 2 to 5 in which inorganic insulating particles that were not surface-treated were added, as is apparent from FIGS. 5 to 8, and FIG. 9, in Comparative Examples 2 to 5, the relative magnetic permeability was lower than that of Comparative Example 1, regardless of which inorganic insulating particles were used.

In contrast, when comparing Comparative Example 1 in which no inorganic insulating particles were added with Examples 1 to 5 in which coated inorganic insulating particles were added, as is apparent from FIGS. 5 to 8 and 9, although the filling rate of the alloy particles was decreased in Examples 1 to 5 in which coated inorganic insulating particles were added, the relative magnetic permeability the same level as in Comparative Example 1 was obtained even when inorganic insulating particles were used. Furthermore, it is shown that, in comparison with Comparative Example 1, Examples 1 to 5 were able to have a very high withstand voltage.

When Comparative Examples 2 to 5 and Examples 1 to 5 are compared for the same type of inorganic insulating particles, it is shown that a high relative magnetic permeability can be achieved by blending coated inorganic insulating particles.

In Examples 1 to 5 in which coated inorganic insulating particles were added, in comparison using the same type of inorganic insulating particles, it is shown that a higher withstand voltage was obtained by adding coated inorganic insulating particles.

### (3) Experiment 2 (Preparation of Composite Magnetic Material)

Next, for comparison with the above Experiment 1, the following experiment was carried out.

### Examples 6 to 21, Comparative Examples 6 to 10

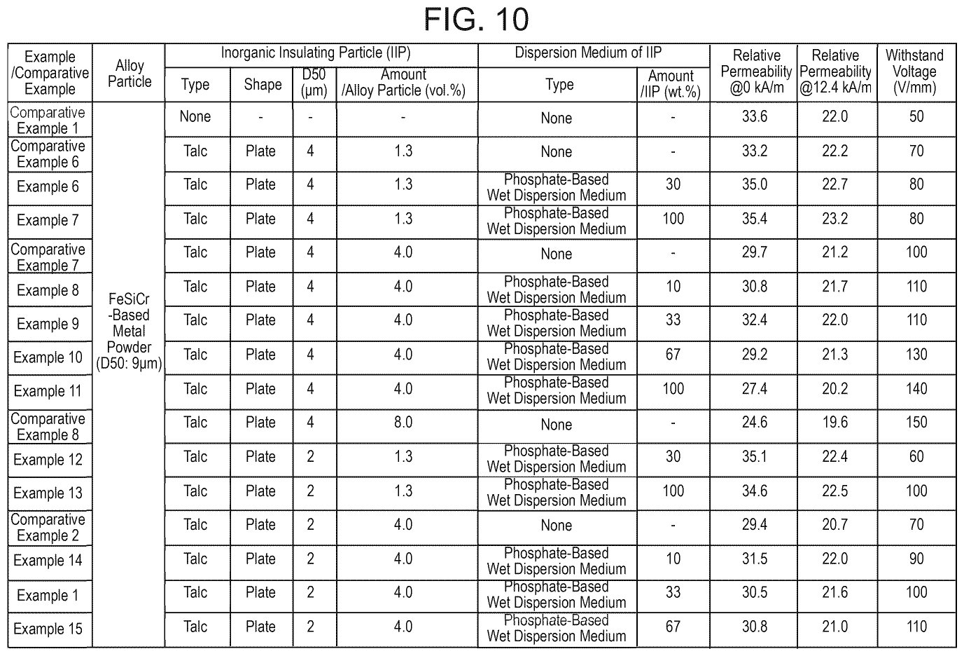

In Examples 6 to 21, as shown in FIG. 10 or. 11, powder of a composite magnetic material was produced in the same conditions as in Example 1 by changing from those in Example 1 described above for one or plural “types”, average particle diameter “D50 (μm)”, and “addition amount (relative to alloy particles (% by volume))” of the inorganic insulating particles, and the “addition amount (relative to inorganic insulating particles (% by volume))” of the dispersant used to coat the surfaces of the inorganic insulating particles.

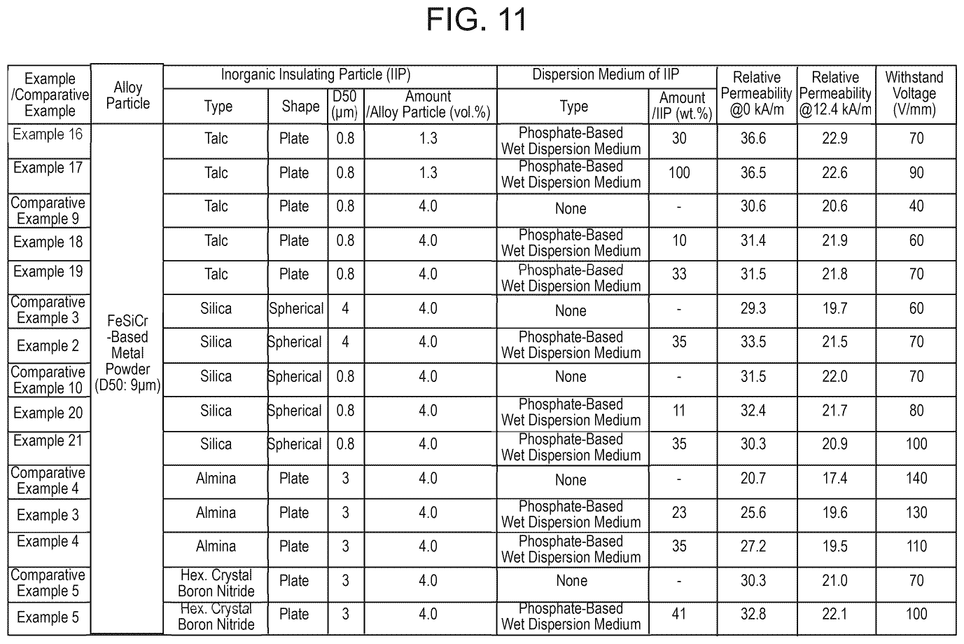

In Comparative Examples 6 to 10, as shown in FIGS. 10 and 11, powder of the composite magnetic material was produced under the same conditions as in Comparative Example 2 by changing from Comparative Example 2 for one or plural of “type” of inorganic insulating particles, the average particle diameter “D50 (μm)”, and the “addition amount (relative to alloy particles (% by volume))”.

Then, also for powder of each of the composite magnetic materials of Examples 6 to 21 and Comparative Examples 6 to 10, the powder was compression-molded under the same conditions as in Comparative Example 1 to produce a toroidal shaped molded body and a disk-shaped molded body as quasi-test pieces, and the molded bodies as quasi-test pieces were cured by heating at 175° C. for 3 hours. Thus, a toroidal shaped cured product test piece and a disk-shaped cured product test piece were obtained.

### (4) Evaluation of Experiment 2

Also, for Examples 6 to 21 and Comparative Examples 6 to 10, under the same conditions as in “(2-1) Evaluation 1: Initial Relative Magnetic Permeability and Relative Magnetic Permeability”, the inductance was measured, and the initial relative magnetic permeability and relative magnetic permeability were calculated. The results are shown in FIGS. 10 and 11.

Furthermore, also for Examples 6 to 21 and Comparative Examples 6 to 10, under the same conditions as in “Evaluation 2: Withstand voltage”, the “voltage [V]” at which the leakage current reached 10 mA or more was measured, and the withstand voltage was calculated. The results are shown in FIGS. 10 and 11. Note here that for comparison, FIGS. 10 and 11 also show the results of the above-mentioned Experiment 1 (Examples 1 to 5 and Comparative Examples 1 to 5).

Also in Experiment 2, when comparing Comparative Example 1 in which no inorganic insulating particles were added, and Comparative Examples 6 to 10 in which inorganic insulating particles that had not been surface-treated were added, with Examples 6 to 21 in which coated inorganic insulating particles were added, it is found that the same tendency was observed as in Experiment 1 described above. That is, it is shown that in Examples 6 to 21, regardless of which inorganic insulating particles were used, a high relative magnetic permeability same level as that of Comparative Example 1 and a much higher withstand voltage than Comparative Example 1 was provided. Furthermore, when comparing Examples 6 to 22 with Comparative Examples 6 to 10 which uses the same type of inorganic insulating particles, it is shown that Examples 6 to 21 had a higher relative magnetic permeability and a higher withstand voltage than Comparative Examples 6 to 10.

### REFERENCE MARKS IN THE DRAWINGS

1 molded body
2 iron-based soft magnetic alloy particle
3 inorganic insulating particle
4 cured product of thermosetting resin
10, 11, 12 powder magnetic core
20 coil conductor
110 power choke coil

1. A composite magnetic material comprising:
iron-based soft magnetic alloy particles;
inorganic insulating particles; and
a thermosetting resin, wherein
surfaces of the inorganic insulating particles are coated with amphiphilic molecules each including a hydrophobic group and a hydrophilic group,
the hydrophobic group includes a hydrocarbon chain, and
the hydrophilic group includes at least one of a phosphoric acid group and a phosphate salt.

2. The composite magnetic material according to claim 1, wherein a relation of 0.09≤D_{Ins}/D_{Cond}≤0.5 is satisfied, where D_{Ins} is an average particle diameter of the inorganic insulating particles and D_{Cond} is an average particle diameter of the iron-based soft magnetic alloy particles.

3. The composite magnetic material according to claim 1, wherein an average particle diameter of the inorganic insulating particles is 0.8 μm or more and 4 μm or less.

4. The composite magnetic material according to claim 1, wherein a ratio of a total volume of the inorganic insulating particles with respect to a total volume of the iron-based soft magnetic alloy particles is 1.3% by volume or more and 4.0% by volume or less.

5. The composite magnetic material according to a claim 1, wherein a ratio of the amphiphilic molecules with respect to a total mass of the inorganic insulating particles is 10% by mass or more and 100% by mass or less.

6. The composite magnetic material according to claim 1, wherein the inorganic insulating particles include coated particles obtained by adding 10% by mass or more and 100% by mass or less of the amphiphilic molecule to 100% by mass of the inorganic insulating particles.

7. A powder magnetic core comprising a cured product of the composite magnetic material according to any claim 1.

8. A power choke coil comprising:
a cured product of the composite magnetic material according to claim 1; and
a coil conductor covered with the cured product of the composite magnetic material.
